(19) United States
(12) Patent Application Publication
(10) Pub. No.: US 2007/0222121 A1
(43) Pub. Date: Sep. 27, 2007

(54) Embossing die

(75) Inventors: Peter Menhofer, Augsburg (DE); Eddy Cornu, Breitenbach (CH); Frank Roland, Konigsbrunn (DE)

Correspondence Address: Charles N.J. Ruggiero;Ohlandt, Greeley, Ruggiero & Perle, L.L.P., 10th Floor, One Landmark Square, Stamford, CT, 06901-2682, US

(73) Assignee: VON ROLL ISOLA GMBH

(21) Appl. No.: 11/449,366

(22) Filed: Jun. 8, 2006

(30) Foreign Application Priority Data
Mar. 22, 2006 (DE) 10 2006 013 184.3

(51) Int. Cl. B29C 70/42

(52) U.S. Cl. 264/494; 264/220; 264/257; 264/337

(57) ABSTRACT

In a method for the manufacture of an embossing due for the cold and hot embossing of paper and cardboard a plane material impregnated with a duroplastic resin is brought into close contact with a shaping die, both are pressed together to obtain a press die from a plane material impregnated with duroplastic resin after hardening of the materials brought into contact with each other.

### TECHNICAL FIELD OF THE INVENTION

The invention relates to a method for manufacturing an embossing die for cold and hot embossing of paper and cardboard and the use of the embossing die made from a material impregnated with a duroplastic resin for cold and hot embossing of paper and cardboard.

### BACKGROUND OF THE INVENTION

The embossing and also multi-colored printing of cardboard articles is frequently an operating stage in the manufacture of higher value product packaging materials or brochures. The embossing dies used for this purpose are frequently plastic materials, for example polyolefin foils or epoxy resins.

In order to manufacture an embossing die from a mixture of an epoxy resin and a hardener for the epoxy resin is applied to a two-piece printing block. The relief printing block and counter printing block are brought into contact with each other under pressure and increased temperature and by curing of the epoxy resin shaping takes place. The disadvantage of this method is that the epoxy resin and hardener have to be pre-weighed, with the possibility of weighing errors. After the resin and hardener are weighed both components must be mixed together thoroughly and uniformly, during which process errors may frequently occur due to the high viscosity and due to inhomogeneities. Are the resin and hardener are mixed together the curing reaction commences, during which the viscosity steadily increases and the mixture can only be used for a limited time. The so-called wet life or pot life may range from a few minutes to several hours at room temperature. The containers and equipment used must be cleaned with solvent before the epoxy resin is cured, provided that no disposable equipment is used. Epoxy resins with an average molecular weight of ≦700 and the hardeners used for cross-linking are dangerous substances and cause skin irritations. Moreover, the resin wells out of the printing block during shaping. Since the resin has already been mixed with the hardener, waste is produced which cannot be re-used for this process.

### SUMMARY OF THE INVENTION

The object of this invention is to provide an embossing die which can be used as an embossing printing block or counter printing block, during whose manufacture the disadvantages previously described are avoided.

This object is achieved by the use of a plane material impregnated with a duroplastic (thermosetting) resin for manufacturing the embossing die. The object is therefore achieved by a method for manufacturing an embossing die for the cold and hot embossing of paper and cardboard in which a plane material impregnated with a duroplastic resin is brought into close contact with a shaping die and is pressed together to obtain an embossing die from a plane material impregnated with duroplastic resin.

The object of the invention is also the use of an embossing die from a plane material impregnated with a duroplastic resin in a method for cold and hot embossing of paper and cardboard. The embossing die according to the invention is suitable for embossing and colored printing of paper and cardboard.

### DETAILED DESCRIPTION OF THE INVENTION

The plane material impregnated with a duroplastic resin may also be described as a pre-impregnate (prepreg). Fabrics and so-called nonwovens are used as plane materials. As raw materials, i.e. in the non-impregnated condition, these plane materials may have a weight per unit area of 30 to 300 g/m², preferably 50 to 150 g/m². These plane materials are commercially available and may be produced from all the usual fibers, i.e. from natural fibers and textile fibers. Suitable fibers include, for example, cellulose, polyester, acrylonitrile, aramide, carbon or glass fibers. The plane materials may also contain different fibers. The fibers may preferably have a diameter of 5 to 20 μm.

The plane raw material is impregnated with a duroplastic resin. The applied amount of resin is 30 to 1000% by weight, related to the weight of the plane raw material. In principle all duroplastic resins are suitable for impregnation, such resins including epoxy resins and unsaturated polyester resins, for example.

For impregnating the plane raw material is guided through an impregnating bath which contains the impregnating solution. The impregnating solution contains a resin, a hardener for the resin, accelerator for the curing reaction and a solvent. The raw material is drawn through the impregnating bath and guided between dosing rolls. These dosing rolls determine the amount of impregnating liquid applied to the plane material. The plane material impregnated with a duroplastic resin is then conveyed through a drying tunnel in which the solvent evaporates. During the drying process partial curing of the duroplastic resin may also take place. The plane material obtained, impregnated with a duroplastic resin, is then cut to the required size. The manufacture of the raw material thus obtained for the method according to the invention is of prior art.

The shaping die is preferably a metal plate which has the convex or recessed pattern to be applied to the embossing die obtained according to the invention. The metal plate may, for example, be an aluminium, magnesium, brass or steel plate. The provision of such metal plates with patterns, i.e. the manufacture of printing blocks, is of prior art and is described, for example, in Ullmann's Encyclopaedia of Technical Chemistry, 4^{th} Edition, 1981, Volume 4, pages 165-178, with further evidence. For example, an aluminium plate is coated by the so-called diazo-positive method with a light sensitive oleophilic compound, for example, o-naphthoquinone diazide, which is embedded in a phenolic resin. A copying model is applied and exposed. During exposure the oleophilic, light sensitive, solvent soluble compound is converted to a carbonic acid which can be elutriated with aqueous alkali (NaOH, KOH), where recesses are formed at the elutriated points. Obviously the metal plate may also be structured by other methods, including mechanical machining of the metal plate, e.g. by milling.

One or more layers of the plane material impregnated with a duroplastic resin are brought into close contact with a shaping die for carrying out the method according to the invention, and the shaping die is then pressed with the plane material impregnated with duroplastic resin. The pressing process preferably takes place with the supply of heat in order to liquefy the resin, fill the shaping die with resin and to ensure that it is cured. For shaping, the temperature used must be sufficiently high for the resin to be thoroughly liquefied and so penetrate and fill the recesses of the shaping die. After curing of the resin the impregnated material is separated from the shaping die to obtain the embossing die according to the invention.

For better separation of the embossing die according to the invention from the shaping die the surfaces of the shaping die and, if necessary, of a further die, may be treated with a release agent. For example, conventional release agents such as silicones, waxes or oils may be applied to the surface of the shaping die. According to a further embodiment, the release agent may already be contained in the duroplastic resin used for impregnation, i.e. it is a component of the plane, impregnated material. The preferred method, though, is to apply a release film to the die surfaces or the plane, impregnated material. Such release films are commercially available under the names Pacothane® or Tedlar® PVF film. Suitable release films of this type are also described in U.S. Pat. No. 4,753,847.

It has proved particularly advantageous initially to place the shaping die in the press, and above it the plane material impregnated with a duroplastic resin, a release agent or film being applied between the plane material and shaping die. It has been observed that in this arrangement the recesses of the shaping die are filled particularly well and that extremely sharp contours are obtainable. A further advantage of the embossing die obtained according to the invention is its long service life, which is longer than that of dies manufactured from pure epoxy resins.

In the method according to the invention temperature, pressure and duration of the pressure and temperature treatment are dependent on the resin used and the desired thickness of the embossing die to be produced. The temperature during pressing of the plane material with the shaping die may be 80 to 200° C., preferably 110 to 170° C. The pressure acting on the impregnated material according to the invention may be 0.5 to 10 MPa (5-100 bars), and the treatment time may be 2 to 30 minutes, preferably 5 to 20 minutes. The embossing die taken from the shaping die and obtained according to the invention may be used as it is as an embossing die.

By using the plane material impregnated with a duroplastic resin instead of a pure epoxy resin, the resin does not well out of the shaping die. Moreover, the problem of skin irritations due to contact with the resin/hardener system, classified as a hazardous material, is eliminated. Finally, there is no complicated weighing of epoxy resin and hardener quantity and the embossing die can be generally manufactured more quickly. Furthermore, the method according to the invention enables embossing dies to be obtained with greater convexities compared to the embossing dies manufactured by the epoxy or araldite method. The embossing die according to the invention is suitable for hot embossing at temperatures of over 150° C. Thus metallic paints can be transferred to paper or cardboard at 160 to 180° C. by use of the embossing die of the invention.

According to an alternative embodiment of the invention, instead of curing at elevated temperature the resin can also be cured with energy-rich radiation, for example UV radiation. Resins suitable for this hardening method are of prior art and are commercially available.

The following example serves as further explanation of the invention.

### EXAMPLE

A laboratory press with thermostatically controllable press plates and a metal shaping die was used. A Pacothane® release film and on top of it five layers of a plane material impregnated with duroplastic resin were applied to the die. The plane material contained a glass fibre nonwoven impregnated with epoxy resin. The glass fibre nonwoven had a non-impregnated weight of 80 g/m² and was impregnated to a total weight of 400 g/m² with an epoxy resin-hardener mixture. A further layer of a release film was then applied. Spacer strips were fitted on the edge of the die to adjust the thickness of the embossing die to be manufactured. These strips were 0.5 mm thicker than the die, thus determining the thickness of the desired product. For the first two minutes the plane material and the die were kept at contact pressure with heat input only. Afterwards the pressure acting on the material to be treated was increased to a value of about 5 MPa and kept at this pressure and a temperature of 140° C. for 15 minutes.

Although the present invention has been described with reference to specific embodiments, various changes and modifications obvious to those skilled in the art are possible without departing from the scope of the appended claims.

We claim:

1. A method for manufacturing an embossing die for the cold and hot embossing of paper and cardboard, comprising bringing a plane material impregnated with a duroplastic resin into close contact with a shaping die and pressing together the plane material impregnated with a duroplastic resin with the shaping die to obtain an embossing die from said plane material impregnated with duroplastic resin.

2. The method according to claim 1, wherein the plane material impregnated with duroplastic resin is formed in a press with thermostatically controllable press dies.

3. The method according to claim 2 wherein the shaping die having two press dies and wherein at least one of said press dies is heated to a temperature of 80 to 200° C. to form the plane material impregnated with duroplastic resin.

4. The method according to claim 1, wherein the plane material impregnated with duroplastic resin is formed and cured by energy-rich radiation, in particular UV radiation.

5. The method according to claim 1, wherein the shaping die is provided with a release film before the introduction of the plane material impregnated with duroplastic resin.

6. The method according to claim 1, wherein the plane material impregnated with duroplastic resin is placed for shaping above the shaping die.
